(19) United States
(12) Patent Application Publication
(10) Pub. No.: US 2011/0020635 A1
(43) Pub. Date: Jan. 27, 2011

(54) MAILABLE MAGNET ASSEMBLY

(76) Inventor: Dale Schaefer, Bessemer, AL (US)

Correspondence Address: BUSH INTELLECTUAL PROPERTY LAW;c/o CPA Global, P.O. Box 52050, Minneapolis, MN, 55402, US

(21) Appl. No.: 12/507,552

(22) Filed: Jul. 22, 2009

(51) Int. Cl. B32B 5/00

(52) U.S. Cl. 428/335; 428/332; 428/334

(57) ABSTRACT

A magnet assembly comprising a flexible magnet secured between two printable substrates that allow the assembly to be mailed without interfering with the automated sorting equipment used by postal services to process mail. One of the substrates partially disrupts the magnetic field of the magnet to prevent the magnet from interfering with the automated sorting equipment, yet allows adequate magnetic effect therethrough such that the magnet assembly can be attached directly to a magnetically receptive surface (e.g. refrigerator) when received by a mail recipient. The other substrate preferably completely disrupts the magnetic field of the magnet to prevent the magnet from interfering with the automated sorting equipment.

### FIELD OF THE INVENTION

The present invention relates to magnetic cards and, more particularly, to a magnet assembly capable of being mailed without interfering with the automated sorting equipment used by postal services.

### BACKGROUND OF THE INVENTION

Magnetic cards are ubiquitous in the prior art and commonly include printed indicia on one side of a substrate and a magnet fixedly attached on the other side. Once a magnetic card reaches an end user, it can be placed on magnetically receptive surfaces (e.g. refrigerator) to advertise a product or service, remind a user of an event, secure a grocery list, and the like. However, sending a magnetic card to an end user through the mail presents a problem. The inherent magnetic nature of the magnetic card can interfere with the automated sorting equipment used by most postal services and thus makes it problematic to process the magnetic cards for delivery.

Accordingly, what is needed, and is not found in the prior art, is a magnetic card capable of being mailed without interfering with the processing equipment used by most postal services.

### SUMMARY OF THE INVENTION

The present invention is a magnet assembly comprising a flexible magnet secured between two printable substrates that allow the assembly to be mailed without interfering with the automated sorting equipment used by postal services to process mail. A first substrate having a printable exterior surface is coextensively and permanently affixed to the first side of the flexible magnet. A second substrate having a printable exterior surface is coextensively and permanently affixed to the second side of the flexible magnet. The printable surface of the first substrate is meant to receive permanent messages, advertisements, or other applicable media. The printable surface of the second substrate is meant to receive the mailing address information of the end user/recipient and sender. The second substrate must be thick enough to partially disrupt the magnetic field of the magnet to prevent the magnet from interfering with the automated sorting equipment used by postal services, however, it must be thin enough that there is adequate magnetic effect therethrough to hold the magnet assembly to a magnetically receptive surface. Once the magnet assembly is delivered via the mail, an end user is able to attach the magnet assembly directly to a magnetically receptive surface on the second substrate side of the magnet assembly which bears the mailing address information. As the magnet assembly adheres to a magnetically receptive surface, the printable surface of the first substrate that bears a permanent message, advertisement, or other applicable media is displayed for the edification of viewers.

These and other features of the invention will become apparent from the following detailed description of the invention.

### BRIEF DESCRIPTION OF THE DRAWING

FIG. 1 is an end view of the preferred embodiment of the present invention.

### DETAILED DESCRIPTION OF THE INVENTION

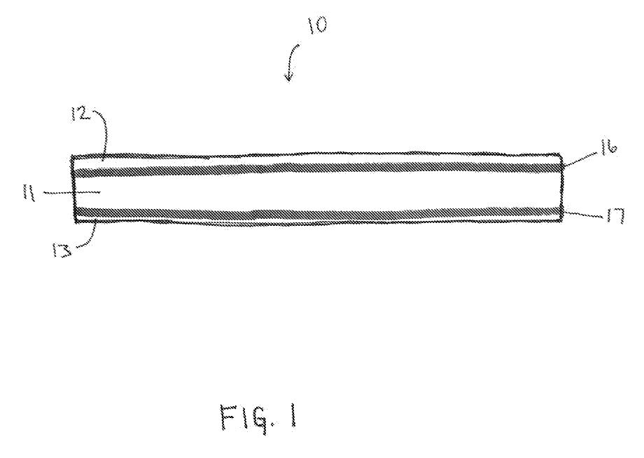

The present invention is a magnet assembly 10 comprising a flexible magnet 11 secured between two printable substrates 12, 13 that allow the assembly to be mailed without interfering with the automated sorting equipment used by postal services to process mail. In the preferred embodiment shown in FIG. 1, the magnet assembly 10 includes a flexible magnet 11 having a first side and a second side. A first substrate 12 having a printable exterior surface is coextensively and permanently affixed to the first side of the flexible magnet 11. A second substrate 13 having a printable exterior surface is coextensively and permanently affixed to the second side of the flexible magnet 11. The first and second substrates 12, 13 can comprise any suitable paper or plastic stock, which may be pre-printed before assembly. Suitable paper substrates include 10-25 lb bond paper. Suitable plastic substrates include oriented polypropylene (OPP) film, styrene, polyvinyl chloride (PVC), acetate, nylon, and other commercially available plastics (e.g. YUPO™, TESLIN™, TYVEK™) capable of bearing printed indicia. The printable surface of the first substrate 12 is meant to receive permanent messages, advertisements, or other applicable media. The printable surface of the second substrate 13 is meant to receive the mailing address information of the end user/recipient and sender.

The second substrate 13 must be thick enough to partially disrupt the magnetic field of the magnet 11 on the second substrate 13 side of the magnet assembly 10 to prevent the magnet 11 from interfering with the automated sorting equipment used by postal services, however, it must be thin enough that there is adequate magnetic effect therethrough to hold the magnet assembly 10 to a magnetically receptive surface. The thickness of the second substrate 13 is preferably 0.5-5.0 mil, most preferably 1.5-3.0 mil. The first substrate 12 preferably has a thickness that completely disrupts the magnetic field of the magnet 11 on the first substrate 12 side of the magnet assembly 10. The thickness of the first substrate 12 is preferably 8-12 mil, most preferably 10 mil. A 3-5 mil layer of laminate (not shown) can be applied to the exterior surface of the first substrate 12, thereby providing protection to the printed first substrate 12, an aesthetic appearance, as well as additional disruption of the magnetic field, in which case the thickness of the first substrate 12 can be reduced.

In manufacturing the magnet assembly 10 of the present invention, the attachment of the substrates 12, 13 to the flexible magnet 11 can be done in a number of conventional manners prior to cutting the combined layers into individual magnet assemblies. A first adhesive coating 16 of a commercially available adhesive material is coextensively applied to an interior surface of the first substrate 12. The adhesive coating 16 permanently bonds the interior surface of the first substrate 12 to the first side of the flexible magnet 11. A second adhesive coating 17 of a commercially available adhesive material is coextensively applied to an interior surface of the second substrate 13. The adhesive coating 17 permanently bonds the interior surface of the second substrate 13 to the second side of the flexible magnet 11. The thickness of the first adhesive coating 16 is preferably 2-3 mil. The thickness of the second adhesive coating 17 is preferably 0.5-1.0 mil. After the foregoing parts are assembled, a sheet comprising the combined layers of the substrates 12, 13 and the flexible magnet 11 can be cut and/or trimmed into individual magnet assemblies ready for shipping.

In use, the aforementioned arrangement of the two substrates 12, 13 with respect to the flexible magnet 11 permits the magnet assembly 10 to pass through automated sorting equipment like a conventional post card without magnetically coupling to other magnet assemblies or other magnetically receptive objects as the respective substrates 12, 13 completely cover both sides of the flexible magnet 11, thereby adequately disrupting the magnetic field of the flexible magnet 11. Once a magnet assembly 10 is delivered via the mail, an end user is able to attach the magnet assembly 10 directly to a magnetically receptive surface on the second substrate 13 side of the magnet assembly 10 which bears the mailing address information. As the magnet assembly 10 releasably adheres to a magnetically receptive surface, the printable surface of the first substrate 12 that bears a permanent message, advertisement, or other applicable media is displayed for the edification of viewers.

While the invention has been shown and described in some detail with reference to a specific exemplary embodiment, there is no intention that the invention be limited to such detail. On the contrary, the invention is intended to include any alternative or equivalent embodiments that fall within the spirit and scope of the invention as described above and as recited in the appended claims.

1. A mailable magnet assembly, comprising:
a. a flexible magnet having a first side and a second side;
b. a first substrate coextensively and permanently affixed to said first side of said flexible magnet; and
c. a second substrate coextensively and permanently affixed to said second side of said flexible magnet;
d. wherein said first substrate has a thickness that completely disrupts a magnetic field of said magnet through said first substrate; and
e. wherein said second substrate has a thickness that partially disrupts a magnetic field of said magnet through said second substrate such that the magnetic field through said second substrate does not interfere with automated postal sorting equipment but is sufficient to reversibly attach said magnet assembly to a magnetically receptive surface.

2. A mailable magnet assembly according to claim 1, wherein said first substrate is 8-12 mil thick.

3. A mailable magnet assembly according to claim 2, wherein said first substrate is 10 mil thick.

4. A mailable magnet assembly according to claim 1, wherein said second substrate is 0.5-5.0 mil thick.

5. A mailable magnet assembly according to claim 4, wherein said second substrate is 1.5-3.0 mil thick.

6. A mailable magnet assembly, comprising:
a. a flexible magnet having a first side and a second side;
b. a first substrate;
c. a first adhesive permanently affixing said first substrate to said first side of said flexible magnet;
d. a second substrate; and
e. a second adhesive permanently affixing said second substrate to said second side of said flexible magnet;
f. wherein said first substrate has a thickness that completely disrupts a magnetic field of said magnet through said first substrate; and
g. wherein said second substrate has a thickness that partially disrupts a magnetic field of said magnet through said second substrate such that the magnetic field through said second substrate does not interfere with automated postal sorting equipment but is sufficient to reversibly attach said magnet assembly to a magnetically receptive surface.

7. A mailable magnet assembly according to claim 6, wherein said first substrate is 8-12 mil thick.

8. A mailable magnet assembly according to claim 7, wherein said first substrate is 10 mil thick.

9. A mailable magnet assembly according to claim 6, wherein said second substrate is 0.5-5.0 mil thick.

10. A mailable magnet assembly according to claim 9, wherein said second substrate is 1.5-3.0 mil thick.

11. A mailable magnet assembly according to claim 6, wherein said first adhesive is 2-3 mil thick.

12. A mailable magnet assembly according to claim 6, wherein said second adhesive is 0.5-1.0 mil thick.

13. A mailable magnet assembly, consisting of:
a. a flexible magnet having a first side and a second side;
b. a first substrate, wherein said first substrate is 8-12 mil thick;
c. a first adhesive permanently affixing said first substrate to said first side of said flexible magnet, wherein said first adhesive is 2-3 mil thick;
d. a second substrate, wherein said second substrate is 0.5-5.0 mil thick; and
e. a second adhesive permanently affixing said second substrate to said second side of said flexible magnet, wherein said second adhesive is 0.5-1.0 mil thick;
f. wherein said first substrate has a thickness that completely disrupts a magnetic field of said magnet through said first substrate; and
g. wherein said second substrate has a thickness that partially disrupts a magnetic field of said magnet through said second substrate such that the magnetic field through said second substrate does not interfere with automated postal sorting equipment but is sufficient to reversibly attach said magnet assembly to a magnetically receptive surface.

14. A mailable magnet assembly according to claim 13, wherein said first substrate is 10 mil thick.

15. A mailable magnet assembly according to claim 13, wherein said second substrate is 1.5-3.0 mil thick.
